(19) United States
(12) Patent Application Publication
(10) Pub. No.: US 2024/0385765 A1
(43) Pub. Date: Nov. 21, 2024

(54) OPTIMIZING STORAGE OF A LARGE VOLUME OF DATA

(71) Applicant: VMware, Inc., Palo Alto, CA (US)

(72) Inventors: Simona Svetozarova Lyubenova, Sofia (BG); Antonio Kristiyanov Filipov, Sofia (BG); Dimitar Veskov Petkov, Sofia (BG); Davor Roglic, Austin, TX (US); Michael Cooper, Washington, DC (US)

(21) Appl. No.: 18/199,898

(22) Filed: May 19, 2023

(51) Int. Cl. G06F 3/06

(52) U.S. Cl. CPC G06F 3/0652; G06F 3/062; G06F 3/0635; G06F 3/067

(57) ABSTRACT

The disclosure provides an approach for storage of a large volume of data. Embodiments include: receiving, from a data source, an event comprising data. Embodiments also include determining a storage object associated with the event based on both the event and the storage object being associated with a first key. Embodiments also include appending the event to the storage object. Embodiments include, in response to the storage object satisfying a flush threshold flushing the storage object to the object storage, and generating a new storage object associated with the first key.

### BACKGROUND

Applications, such as services, often generate a large amount of data that needs to be stored. These applications may include, for example, (i) a service that monitors network traffic for anomalous behavior and may generate incident reports and metadata about detected anomalous behavior, (ii) an antivirus application that produces results from analyzing files, (iii) a service that monitors banking transactions for fraudulent transactions and generates data about analyzed transactions, etc. Each unit of data generated by an application may sometimes be referred to as an “event” or “event data” because, for example, the data may be indicative of occurrence of an activity or other action. However, as used herein, an event can be any type of data. Applications can generate a large number of events. A large number of events can be difficult to process as they are received. Thus, the events may be stored for future processing, such as in a cloud-based storage solution, on-premises data store, and/or the like.

However, storing these events can also present difficulties. Different types of storage present different challenges. For example, each event may be stored as a separate file as the event is received at a storage. Further, events may be received at storage often, such as every second. Therefore, storing the events as separate files can result in a large number of small files being stored in the storage with an accompanying large number of write commands to the storage.

For certain types of storage, having a large number of small files stored can lead to latency in reading data, such as latency for reading a large number of the small files when trying to later process the events. In particular, each read of a file from storage, regardless of the size of the file, has an associated latency overhead. For example, metadata of each file may need to be processed to be read, which may take on the order of milliseconds. As a larger number of files, such as millions of files, is read, the milliseconds add up to substantial latency.

### BRIEF DESCRIPTION OF THE DRAWINGS

FIG. 1 depicts a system in which embodiments of the present disclosure may be implemented.

FIG. 2 illustrates an example path for storing data into a storage system, according to embodiments of the present disclosure.

FIG. 3 illustrates an example storage object, according to embodiments of the present disclosure.

FIG. 4 illustrates an example event glossary, according to embodiments of the present disclosure.

FIG. 5 is a flowchart of an example method to store event data in a storage object, according to embodiments of the present disclosure.

FIG. 6 is a flowchart of an example method to flush the event data in the storage object into object storage, according to embodiments of the present disclosure.

FIG. 7 is a flowchart of an example method to handle asynchronous flush triggers, according to embodiments of the present disclosure.

FIG. 8 is a flowchart of an example method to retrieve event data from object storage, according to embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides improved systems and methods for storing a large number of events. As described herein, prior to storing events in storage, a storage manager groups related events into any suitable data structure, such as a file, which may be referred to as a storage object, where each storage object may contain multiple events. Each storage object may then be written as a single file to storage, such as in one write command. The storage may be referred to as an object storage due to it storing the storage objects. Further, as discussed herein, offsets are maintained that indicate the location of each event within the storage object, ensuring that each individual event is separately retrievable from the storage. Accordingly, instead of storing each event as a separate file, techniques herein allow for multiple events to be grouped together in a single storage object that can be written to storage, which reduces the number of writes to storage, which can reduce latency for writing the data to storage.

The storage manager receives events from one or more data sources. A data source may be any application that generates events that need to be stored and subsequently analyzed. For example, the data sources may be monitoring or logging services. As an example, the storage manager may receive events from a service that monitors network traffic for anomalous behavior. In such an example, the service may generate events, where each event is a report that provides data and metadata about an incident of allegedly anomalous network traffic.

The storage manager may receive events from multiple data sources. To identify events to append together in the same storage object, each event is associated with a key. Events from a data source or a group of related data sources may be associated with the same key. Conversely, events from different, unrelated data sources may be associated with different keys. For example, events received from a first data source may be assigned a first key and events from a second data source may be assigned a second key. In such an example, the storage manager may use the events from the first data source to create a first storage object and the events from the second data source to create a second storage object.

In certain aspects, the storage manager writes the storage object to object storage (sometimes referred to as “flushing” to object storage) when the storage object satisfies a flush threshold. For example, the flush threshold may specify a threshold number of events stored in the storage object. In such an example, the storage object satisfies the flush threshold when the storage object includes at least the threshold number of events. As another example, the flush threshold may specify a threshold size (e.g., in bytes) for the storage object. In such an example, the storage object satisfied the flush threshold when the storage object reaches at least the threshold size.

Object storage provides write-once, read-many storage of storage objects in object spaces. Object spaces are subdivisions of the object storage that facilitate storing groups of storage objects together. Each object space within object storage has a unique object space identifier to help establish and maintain these subdivisions. The object spaces may be divided by (i) data source, such that storage objects that contain events from the same data source are stored together, (ii) storage manager, such that storage objects created by the same storage manager are stored together, or (ii) account, such that storage objects associated with a particular account holder are stored together, etc. Buckets provided by Amazon® Simple Storage Service (Amazon S3) are an example of the object spaces as used herein. The object storage may be, for example, an on-premises object storage or a cloud-based object storage. The object storage may include physical storage devices and one or more servers or other computing devices configured to manage storage of objects on the physical storage devices.

A unique location reference is generated for each event in the object storage to facilitate retrieving the event from storage. As used herein, a location reference is sometimes referred to as a “glossary.” A glossary specifies the object space identifier within the object storage in which the storage object is stored, the path for the storage object that contains the event, and a location of the event within the storage object. Glossaries may be stored such that an application that processes the events (sometimes referred to herein as an “event analyzer”) may access the glossaries to retrieve any particular event from object storage. For example, an event analyzer, such as a security management service, may use the glossaries to retrieve events that were generated based on suspicious network traffic originating from a specific Internet protocol (IP) address. In some examples, the glossaries also include a portion of the data from the event to facilitate the event analyzer subsequently determining whether the event needs to be retrieved from the object storage. For example, the event may include a destination IP address, which may be included when the glossary is generated.

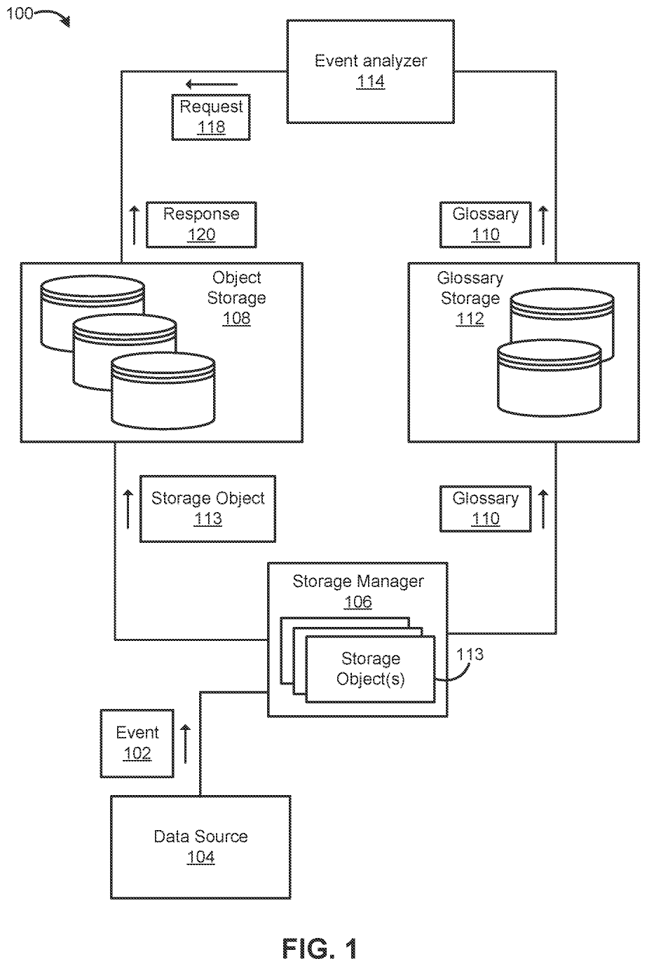

FIG. 1 illustrates a system 100 to manage storage and retrieval of a large number of events 102. In the illustrated example, the system 100 includes at least one data source 104 that generates events 102. A storage manager 106 manages storage of the events 102 in an individually retrievable manner into object storage 108 and generates glossaries 110 to be stored in glossary storage 112 to facilitate an event analyzer 114 retrieving events 102 from the object storage 108. While one data source 104 is illustrated for exemplary purposes, many related or unrelated data sources may be communicatively coupled to the storage manager 106 as described herein.

The data source 104 may be any application that generates events 102. In certain aspects, the data source 104 is an application that monitors network activity. For example, a data source 104 may be an application monitoring network activity and the events 102 may be generated in response to suspicious network activity. In such an example, the events 102 may include data relating to a source of the suspicious traffic, data relating to a destination of suspicious traffic, and/or a timestamp of when the suspicious traffic was captured, etc. As another example, the data source 104 may be an antivirus service that generates an event 102 after analyzing the contents of a file sent over a network. In such an example, the event 102 may include data regarding the sender (e.g., email address, source IP address, etc.), data regarding the recipient (e.g., email of the recipient, an identifier of the computer on which computer the filed was scanned), a timestamp, a name of the file scanned, and/or a code related to any suspicious content of the file, etc.

Each data source 104 may operate on a physical device (e.g., server, computing device, etc.) or virtual device (e.g., virtual computing instance, container, virtual machine (VM), etc.). For example, a physical device may include hardware such as one or more central processing units, memory, storage, and physical network interface controllers (PNICs). A virtual device may be a device that represents a complete system with processors, memory, networking, storage, and/or BIOS, that runs on a physical device. For example, the physical device may execute a virtualization layer that abstracts processor, memory, storage, and/or networking resources of the physical device into one more virtual devices.

The storage manager 106 creates storage objects 113. In certain aspects, the storage manager (e.g., temporarily) stores the created storage objects 113 on local memory and/or storage of the storage manager 106 prior to flushing the storage objects 113 to object storage 108. When an event 102 is received by the storage manager 106, the storage manager 106 appends the event 102 to the end of a storage object 113. When the storage object 113 satisfies the flush threshold, the storage manager 106 flushes the storage object 113 to the object storage 108. The storage manager 106 then begins to build a new storage object 113 with events 102 received after the flush. Additionally, in some examples, when the storage manager 106 receives events from multiple data sources, the storage manager 106 may build multiple storage objects 113 concurrently. In such examples, to identify events that are to be stored together in a storage object, the storage manager 106 uses keys associated with the events. A key identifies which events are to be stored together in a storage object. For example, events associated with the key “x5Y” may be appended together in a first storage object and events associated with the key “6fW” may be appended together in a second storage object. In some examples, the storage manager 106 maintains a table that associates data sources 104 with keys such that events 102 received from a particular data source 104 are associated with the corresponding key. In some examples, the event 102 may include the key. In some examples, the key may be included in with data associated with transmission of the event 102 (e.g., in a transmission header, etc.).

To facilitate storing the storage objects 113 in the object storage 108, the storage manager 106 receives configuration information for each data source 104 from which events 102 are received. The configuration information may be received, for example, from an administrator. In certain aspects, the configuration information specifies (i) an identifier of the object space in the object storage 108 to store the storage object 113, (ii) a key, (iii) information (e.g., a base prefix, etc.) to generate a path for the storage object 113 (iii) a flushing threshold, and/or (iv) a threshold period of time before flushing the storage object 113. In some examples, the configuration information may also specify a portion of the event 102 to be included in a glossary 110 as described below.

To facilitate storing storage objects 113 in unique locations within the object space, the storage manager 106 generates a path for each storage object 113. The path defines the location within the object space to which the storage object data 113 will be stored. In some examples, a path is generated when the storage manager 106 receives the first event 102 to be added to the storage object 113. In some examples, a new path is generated for a new storage object 113 when a previous storage object 113 is flushed to the object storage 108 to facilitate the storage manager 106 building the new storage object 113 with subsequently received events 102.

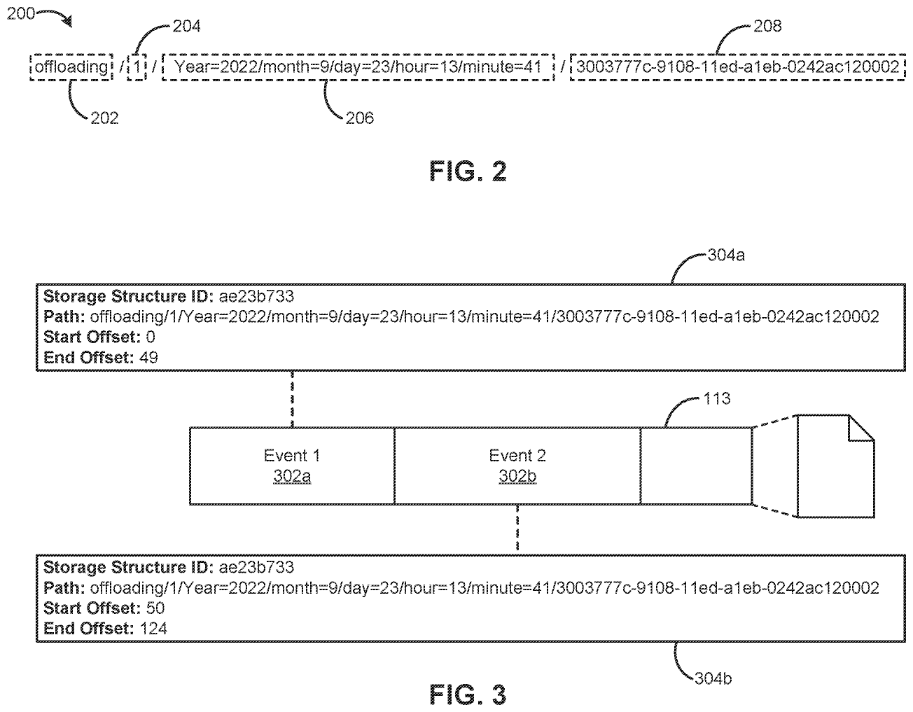

FIG. 2 illustrates an example of a path 200. In the illustrated example, the path includes a base prefix 202, a key 204, a creation date 206, and a unique identifier 208. In certain aspects, the base prefix 202 is a common prefix for all storage objects 113 stored in the object storage 108 by the same storage manager 106. The base prefix 202 may divide the object space into subdivisions. For example, the base prefix 202 may be associated with the storage manager 106 such that the storage objects 113 stored by the storage manager 106 share the same base prefix 202. In such an example, a different storage manager may be associated with a different base prefix. Alternatively, in some examples, the base prefix 202 may be associated with an operator of the storage manager 106 and/or event analyzer 114 such that the storage object data 113 stored by storage managers 106 associated with the operator share the same base prefix 202. The key 204 is the key as described above. The creation date 206 is associated with the date and time that the path 200 is generated by the storage manager 106. The unique identifier 208 is a random identifier generated by the storage manager 106 when the storage manager 106 generates the path 200. Every time the path 200 is generated for a storage object 113 to store events 102 associated with a particular key 204, (i) the base prefix 202 and the key 204 remain constant and (ii) the creation date 206 and the unique identifier 208 change. Thus, every storage object 113 is assigned a unique path 200.

FIG. 3 illustrates an example of the storage object 113. The storage object 113 concatenates events 302a and 302b (collectively “events 302”) together. The events 302 may be examples of the event 102 of FIG. 1. In the illustrated example, two events 302a and 302b are depicted for illustrative purposes. When the first event 302a is received, the storage manager 106 adds the bytes of the first event 302a to the beginning of the storage object 113. When the second event 302b is received, the storage manager 106 concatenates the bytes of the second event 302b to the end of the bytes of the first event 302a. This continues until, for example, the flushing threshold is satisfied.

For each one of the events 302 appended to the storage object 113, the storage manager 106 generates a corresponding location reference 304a and 304b (collectively “location references 304”). Each of the location references 304 includes the information necessary for the event analyzer 114 to subsequently individually retrieve the events 302 from the object storage 108. In the illustrated example, the location references 304 include (i) a storage structure identifier (SSID), (ii) the current path generated for the storage object 113, (iii) a start offset value, and (iv) an end offset value. The SSID is an example of the object space identifier that specifies the object space within the object storage 108 to which the storage object 113 will be flushed. The path identifies a location within the object space identified by the SSID to which the storage object 113 will be flushed. The start offset value identifies the byte within the storage object 113 that the event 302 starts. The end offset value identifies the byte within the storage object 113 that the event 302 ends. For example, if the first event 302a has a size of 50 bytes, the start offset value would be 0 (e.g., the beginning of the storage object 113) and the end offset value would be 49. In that example, if the second event 302b has a size of 75 bytes, the start offset value would be 50 and the end offset value would be 124.

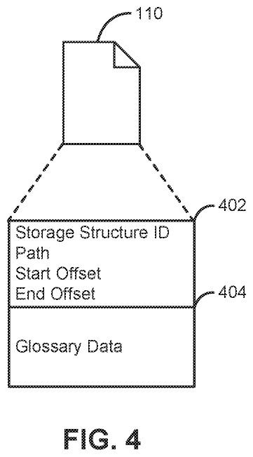

Returning to FIG. 1, when an event 102 is inserted into the storage object 113, the storage manager 106 generates a glossary 110. The storage manager 106 then stores the glossary 110 in the glossary storage 112. FIG. 4 illustrates an example of the glossary 110. In the illustrated example, the glossary includes a location reference 402 and glossary data 404. The location reference 402 may be an example of the location reference 304 of FIG. 3. To populate the glossary data 404, the storage manager 106 selects a portion of the corresponding event 102. For example, the glossary data 404 may include a portion of the event 102 that facilitates the event analyzer 114 determining whether the event 102 should be retrieved from object storage 108. The portion of the event 102 to be stored in the glossary data may be specified when the storage manager 106 is configured to receive events 102 from the data source 104. In some examples, the event analyzer 114 provides a configuration file to the storage manager 106 that identifies the portion of the event 102 to place in the glossary data 404. For example, if the event analyzer 114 is a network security service, the glossary data 404 may include a name or other identifier of the file that was analyzed by the data sources 104 included in the event 102.

The storage manager 106 may operate on a physical device (e.g., server, computing device, etc.) or virtual device (e.g., virtual computing instance, container, virtual machine (VM), etc.). The storage manager 106 may store storage objects 113 in local memory or any storage available to the storage manager 106, such as physical storage or network storage.

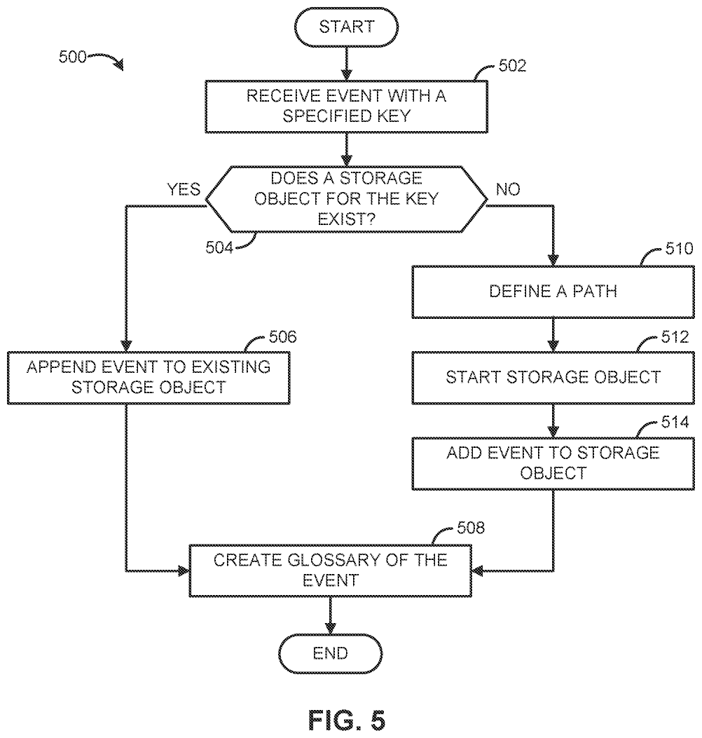

FIG. 5 is a flowchart of an example method to store events (e.g., the events 102 of FIG. 1) in a storage object (e.g., the storage object 113 of FIG. 1). Operations 500 begin at step 502 with receiving, by a storage manager (e.g., the storage manager 106 of FIG. 1), an event from a data source (e.g., the data source 104 of FIG. 1). The event may be generated by the data source, for example, in response to detecting a suspicious file on a network. The event is received with a key and/or a key is assigned to the event based on the data source from which it was received.

Operations 500 continue a step 504 with determining, by the storage manager 106, whether a storage object exists that is associated with the key. A storage object may not exist, for example, when the event is the first event received associated with the key.

When a storage object exists that is associated with the key, operations 500 continue at step 506 with appending, by the storage manager, the bytes of the event to the end of the bytes of the storage object.

Operations 500 continue with step 508 with generating, by the storage manager, a glossary of the event to be stored in glossary storage (e.g., the glossary storage 112 of FIG. 1).

When a storage object associated with the key does not exist, operations 500 continue at step 510 with defining a path for a storage object.

Operations 500 then continue at step 512 with creating, by the storage manager, a storage object to be associated with the key and the path.

Operations 500 continue at step 514 with storing the bytes of the event at the beginning of the storage object.

Operations 500 continue with step 508 with generating, by the storage manager, a glossary of the event to be stored in glossary storage.

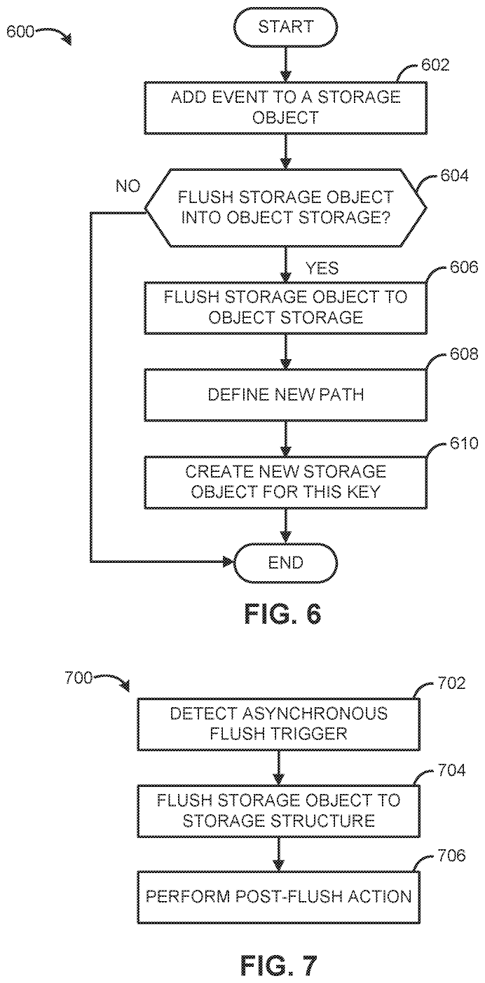

Returning to FIG. 1, the storage object 113 is flushed into the object storage 108, such as based on a flushing threshold being met, or an asynchronous flush trigger occurring. The storage object data 113 is written to a location in the object storage 108 defined by the SSID and the path of the storage object 113. FIGS. 6 and 7 illustrate example methods of flushing the storage object data 113 into the object storage 108.

As illustrated in FIG. 6, operations 600 begin at step 602 with adding, by a storage manager (e.g., the storage manager 106 of FIG. 1), an event into a storage object (e.g., the storage objects 113 of FIG. 1). Examples of adding an event into the storage object are described in connection with operations 500 of FIG. 5.

Operations 600 continue at step 604 with determining, by the storage manager, whether to flush the storage object (e.g., storage object 113 of FIGS. 1 and 3) into object storage (e.g., the object storage 108). In some examples, the storage manager determines to flush the storage object into the object storage in response to a threshold number of events being stored within the storage object. Alternatively or additionally, in some example, the storage manager determines to flush the storage object into object storage in response to storing a threshold number of bytes in the storage object.

When the storage object is to be flushed into the object storage, operations 600 continue at step 606 with flushing the storage object into object storage based on the SSID of the object space within the object storage and the path defined for the storage object.

Operations 600 continue at step 608 with defining, by the storage manager, a new storage path for a new storage object. Because the path is a unique identifier within the object storage for the location of storage object data, each time the storage object data is flushed to the object storage, the storage manager defines a new path for the storage object.

Operations 600 continue at step 610 with create, by the storage manager, a new, empty storage object.

As illustrated in FIG. 7, operations 700 begin at step 702 with detecting, by a storage manager (e.g., the storage manager 106 of FIG. 1), an asynchronous flush trigger. An asynchronous flush trigger causes the storage manager to flush the storage object (e.g., the storage object 113 of FIG. 1) into object storage (e.g., the object storage 108 of FIG. 1) before the storage object satisfies a flushing threshold as described above.

One example asynchronous flush trigger includes determining that no new event has been received for storage in the storage object for a threshold period of time (e.g., an hour). In such an example, the storage manager tracks an elapsed time since an event was last added to the storage object. This asynchronous flush trigger occurs when the elapsed time is greater than the threshold period of time. The threshold period of time may be configured when the storage object is defined. In another example, an asynchronous flush trigger is reception of a flush command at the storage manager, such as from an administrator or client. In another example, an asynchronous flush trigger includes the storage manager receiving a message that the key associated with events from a data source is being discontinued. For example, the data source associated with the key may be terminated and no longer sending events. In another example, an asynchronous flush trigger includes a fault or other error of the storage manager that is expected to hinder the operation of the storage manager.

Operations 700 continue at step 704 with flushing, by the storage manager, the storage object into object storage based on the SSID of the object space and the path of the storage object.

Operations 700 continue at step 706 with performing, by the storage manager, post-flush actions. The post-flush actions may depend on the asynchronous flush trigger. In some examples, the post flush actions may be defining a new storage path for a new storage object. Additionally or alternatively, in some examples, the storage manager may delete or otherwise destroy the storage object. For example, when the key is discontinued, the storage manager ceases creating storage objects with events associated with the key.

Returning to FIG. 1, an event analyzer 114 processes data generated by the data sources 104. As part of processing this data, the event analyzer 114 may determine what data generated by the data source 104 is of use based on the glossaries 110. Using the location reference in the glossaries 110, the event analyzer 114 retrieves events 102 from the object storage 108 for further processing. The event analyzers 114 may retrieve one and process one glossary 110 at a time (e.g., as the glossaries are stored in the glossary memory 112, etc.) or may retrieve batches of glossaries 110 to be processed. The event analyzer 114 operates on physical devices (e.g., servers, computing devices, etc.) or virtual devices (e.g., virtual computing instances, containers, virtual machines (VMs), etc.). The event analyzer 114 may or may not operate on the same device as the data sources 104. In some examples, the event analyzer 114, the storage manager 106, and/or data sources 104 may be operating in different networks.

The event analyzer 114 receives or otherwise retrieves the glossaries 110 from the glossary storage 112. The glossaries 110 facilitate the event analyzer 114 determining which of the events 102 contain data of interest for retrieval. In some examples, the event analyzer 114 may process the glossaries 110 singularly looking for glossary data of interest. For example, the event analyzer 114 may determine that glossary data that indicates a particular file name is associated with an event 102 that may include additional data of interest. In some examples, the event analyzer 114 may process the glossaries in the aggregate, looking for patterns that signify which data is useful. For example, the event analyzer 114 may, based on a pattern of anomalous activity from a particular source IP address identified in the glossary data, determine to retrieve events from object storage 108 related to that particular source IP address.

To retrieve a specific event 102 from the object storage 108, the event analyzer 114 sends a request 118 that specifies the location reference (e.g., the location reference 402 of FIG. 4) included in the corresponding glossary 110. Upon receipt of the request, the object storage 108 returns a response 120 that includes the requested event 102 based on the SSID, the path, the start offset, and the end offset.

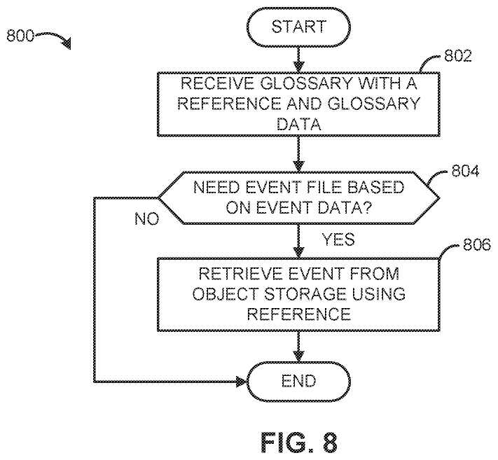

FIG. 8 illustrates and example method to retrieve an event (e.g., the event 102 of FIG. 1) from object storage (e.g., the object storage 108 of FIG. 1). As illustrated in FIG. 8, operations 800 begin at step 802 with receiving or otherwise retrieving, by a client (e.g., the event analyzer 114 of FIG. 1), a glossary (e.g., a glossary 110 of FIGS. 1 and 4) that contains a location reference (e.g., the location reference 402 of FIG. 4) and glossary data (e.g., the glossary data 404 of FIG. 4).

Operations 800 continue at step 804 with determining, by the client, whether the event is needed that corresponds with the glossary. For example, the client may include one or more criteria that specify when, based on the event data, the event is necessary for further processing.

When the event is needed, operations 800 continue at step 806 with retrieving, from the object storage, the event based on the SSID, the path, the start offset, and the end offset set forth in the reference.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and/or the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

1. A method for storing events in an object storage, the method comprising:
receiving, by a storage manager running on a computing device, from a data source, an event comprising data;
determining, by the storage manager, a storage object associated with the event based on both the event and the storage object being associated with a first key, wherein the storage object is stored on the computing device;
appending, by the storage manager, the event to the storage object; and in response to the storage object satisfying a flush threshold:
flushing, by the storage manager, the storage object to the object storage; and
generating, by the storage manager, a new storage object associated with the first key.

2. The method of claim 1, further comprising:
receiving, by the storage manager, from a second data source, a second event;
determining, by the storage manager, a second storage object associated with the second event based on both the second event and the second storage object being associated with a second key; and
appending, by the storage manager, the second event to the second storage object.

3. The method of claim 1, further comprising:
generating, by the storage manager, a first path that specifies a first location in storage to store the storage object; and
generating, by the storage manager, a second path that specifies a second location in storage to store the new storage object.

4. The method of claim 1, wherein the flush threshold is a number of events or a size, and the flush threshold is satisfied when the storage object stores at least the number of events or is of at least the size.

5. The method of claim 1, further comprising generating a glossary for the event, wherein the glossary includes a location within the storage object of the event.

6. The method of claim 5, wherein the glossary includes a portion of the event.

7. The method of claim 5, further comprising storing the glossary in a second storage different from the object storage.

8. The method of claim 5, wherein the location within the storage object of the event is defined by a start offset byte and an end offset byte.

9. A system comprising:
at least one local memory; and
at least one processor coupled to the at least one local memory, the at least one processor and the at least one local memory configured to:
receive, from a data source, an event comprising data;
determine a storage object associated with the event based on both the event and the storage object being associated with a first key, wherein the storage object is stored on the computing device;
append the event to the storage object; and
in response to the storage object satisfying a flush threshold:
flush the storage object to an object storage; and
generate a new storage object associated with the first key.

10. The system of claim 9, wherein the at least one processor and the at least one local memory are further configured to:
receive, from a second data source, a second event;
determine a second storage object associated with the second event based on both the second event and the second storage object being associated with a second key; and
append the second event to the second storage object.

11. The system of claim 9, wherein the at least one processor and the at least one local memory are further configured to:
generate a first path that specifies a first location in storage to store the storage object;
and generate a second path that specifies a second location in storage to store the new storage object.

12. The system of claim 9, wherein the flush threshold is a number of events or a size, and the flush threshold is satisfied when the storage object stores at least the number of events or is of at least the size.

13. The system of claim 9, wherein the at least one processor and the at least one local memory are further configured to generate a glossary for the event, wherein the glossary includes a location within the storage object of the event.

14. The system of claim 13, wherein the glossary includes a portion of the event.

15. The system of claim 13, wherein the at least one processor and the at least one local memory are further configured to store the glossary in a second storage different from the object storage.

16. The system of claim 13, wherein the location within the storage object of the event is defined by a start offset byte and an end offset byte.

17. A non-transitory computer-readable medium storing instructions that, when executed by one or more processors of a server, cause the one or more processors to:
receive, from a data source, an event comprising data;
determine a storage object associated with the event based on both the event and the storage object being associated with a first key, wherein the storage object is stored on the computing device;
append the event to the storage object; and
in response to the storage object satisfying a flush threshold:
flush the storage object to an object storage; and
generate a new storage object associated with the first key.

18. The non-transitory computer-readable medium of claim 17, wherein the instructions, when executed by the one or more processors, further cause the one or more processors to:
receive, from a second data source, a second event;
determine a second storage object associated with the second event based on both the second event and the second storage object being associated with a second key; and
append the second event to the second storage object.

19. The non-transitory computer-readable medium of claim 17, wherein the instructions, when executed by the one or more processors, further cause the one or more processors to:
generate a first path that specifies a first location in storage to store the storage object; and
generate a second path that specifies a second location in storage to store the new storage object.

20. The non-transitory computer-readable medium of claim 17, wherein the instructions, when executed by the one or more processors, further cause the one or more processors to generate a glossary for the event, wherein the glossary includes a location within the storage object of the event and a portion of the event and, wherein the location within the storage object of the event is defined by a start offset byte and an end offset byte.
